(19) United States
(12) Patent Application Publication
(10) Pub. No.: US 2010/0195903 A1
(43) Pub. Date: Aug. 5, 2010

(54) IMAGE PROCESSING DEVICE, DATA-SET GENERATING DEVICE, COMPUTER READABLE STORAGE MEDIUM STORING IMAGE PROCESSING PROGRAM AND COMPUTER READABLE STORAGE MEDIUM STORING DATA-SET GENERATING PROGRAM

(75) Inventor: Shinsuke Tani, Tokyo (JP)

Correspondence Address: SCULLY SCOTT MURPHY & PRESSER, PC, 400 GARDEN CITY PLAZA, SUITE 300, GARDEN CITY, NY, 11530, US

(73) Assignee: OLYMPUS CORPORATION, Tokyo (JP)

(21) Appl. No.: 12/690,460

(22) Filed: Jan. 20, 2010

(30) Foreign Application Priority Data
Jan. 21, 2009 (JP) 2009-010811

(51) Int. Cl. G06K 9/00

(52) U.S. Cl. 382/162

(57) ABSTRACT

Provided is an image processing device that includes: a data-set generating unit that generates a plurality of data sets in which spectral information and color information corresponding to the spectral information are set as a pair; an associating unit that associates a stained sample image with at least one of data sets generated by the data-set generating unit based on color information of the stained sample image and color information of the respective data sets; and a spectral-information extracting unit that extracts spectral information used for estimating spectral characteristics of the stained sample according to the association of data sets by the associating unit.

### CROSS-REFERENCE TO RELATED APPLICATIONS

This application is based upon and claims the benefit of priority from Japanese Patent Application No. 2009-010811, filed on Jan. 21, 2009, the entire contents of which are incorporated herein by reference.

### BACKGROUND OF THE INVENTION

1. Field of the Invention

The present invention relates to an image processing device, a data-set generating device, a computer readable storage medium storing an image processing program, and a computer readable storage medium storing a data-set generating program.

2. Description of the Related Art

One of physical quantities expressing a physical property specific to a subject of imaging is a spectral transmittance spectrum. Spectral transmittance is a physical quantity expressing a ratio of transmitted light to incident light at each wavelength, and is specific information of an object, whose value does not change due to an extrinsic influence. It is different from color information that depends on a change of illumination light, such as an RGB value. Therefore, the spectral transmittance is used in various fields as information for reproducing the color of the subject itself. For example, for a body tissue sample, particularly in the field of pathological diagnosis using pathological specimens, a technique for estimating spectral transmittance has been used for analysis of images acquired by imaging samples.

In pathological diagnosis, a process is widely practiced such that a pathological specimen is magnified to be observed using a microscope after slicing a block sample obtained by excision of an organ or a pathological specimen obtained by needle biopsy into pieces having a thickness of about several microns to obtain various findings. Transmission observation using an optical microscope is one of observation methods most widely practiced, because materials for optical microscopes are relatively inexpensive and easy to handle, and this method has been used for many years. In a case of transmission observation, because a sliced sample hardly absorbs or scatters light and is substantially transparent and colorless, it is common to stain the sample with a dye prior to observation.

Various methods have been proposed as the staining method, and there have been more than a hundred methods in total. Particularly for pathological specimens, hematoxylin-eosin stain (hereinafter, “H&E stain”) using bluish purple hematoxylin and red eosin has been generally used.

Hematoxylin is a natural substance extracted from plants, and has no stainability itself. However, hematin, which is an oxide of hematoxylin, is a basophilic dye and combines with a substance negatively charged. Because deoxyribonucleic acid (DNA) included in a cell nucleus is negatively charged due to a phosphate group included therein as a structural element, the DNA combines with hematin to be stained bluish purple. As described above, substance having stainability is not hematoxylin but its oxide, namely hematin. However, because it is common to use hematoxylin as the name of dye, this applies to the following explanations. Meanwhile, eosin is an acidophilic dye, and combines with a substance positively charged. Amino acid and protein are charged positively or negatively depending on its pH environment, and have a strong tendency to be charged positively under acidity. For this reason, there are cases that acetic acid is added to eosin. The protein included in a cytoplasm combines with eosin to be stained red or light red.

In a sample subjected to H&E stain (a stained sample), cell nucleuses, bone tissues and the like are stained bluish purple, and cytoplasm, connective tissues, red corpuscles and the like are stained red, to have them become easily visible. Accordingly, an observer can ascertain the size, positional relation or the like of elements structuring a cell nuclei or the like, thereby enabling to determine a state of the sample morphologically.

Observation of stained samples is performed by multiband imaging the stained samples to be displayed on a display screen of an external device, in addition to visual inspection by an observer. In a case of displaying images on a display screen, processing for estimating spectral transmittance at each sample point from the obtained multiband image, processing for estimating a dye amount of a dye with which the sample is stained based on the estimated spectral transmittance, processing for correcting the color of the image based on the estimated dye amount and the like are performed. Variation in the property of camera, the stained state and the like are then corrected, and an RGB image for display of the stained samples is composed. FIG. 17 is an example of a composed RGB image. When the estimation of a dye amount is appropriately performed, samples stained darker or stained lighter can be corrected to an image in a color equivalent to a sample that is properly stained. Therefore, highly accurate estimation of the spectral transmittance of the stained sample leads to estimation of the dye amount fixed to the stained sample and high accuracy in correction of staining difference.

As a method of estimating spectral transmittance at each sample point from a multiband image of stained samples, for example, an estimation method by principal component analysis (see, for example, “Development of support systems for pathology using spectral transmittance—The quantification method of stain conditions”, Proceedings of SPIE, Vol. 4684, 2002, p. 1516 to 1523), and an estimation method by the Wiener estimation (for example, see “Color Correction of Pathological Images Based on Dye Amount Quantification”, OPTICAL REVIEW, Vol. 12, No. 4, 2005, p. 293-300) can be mentioned. The Wiener estimation is widely known as a technique of linear filtering methods for estimating an original signal from an observed signal on which noise is superimposed, which is a method for minimizing an error, by taking into consideration statistical properties of an observed object and properties of imaging noise (observation noise). Because some noise is included in signals from a camera, the Wiener estimation is very useful as a method for estimating an original signal.

The method of estimating spectral transmittance at each sample point from a multiband image of a stained sample according to the Wiener estimation method is explained below.

First, a multiband image of the stained sample is captured. For example, a technique disclosed in Japanese Laid-open Patent Publication No. 07-120324 is used to capture a multiband image according to a frame sequential method, while switching 16 pieces of bandpass filters by rotating a filter wheel. In this way, multiband images having pixel values of 16 bands at each point of the stained sample can be obtained. Although the dye is three-dimensionally distributed in the sample as the original observed object, it cannot be captured as a three-dimensional image as it is with an ordinary transmission observation system, and is observed as a two-dimensional image in which illumination light that has passed the stained sample is projected on an imaging element of the camera. Accordingly, each point mentioned herein signifies a point on the stained sample corresponding to each projected pixel of the imaging element.

For a position x of a captured multiband image, a relation expressed by the following Equation (1) based on a response system of the camera is established between a pixel value g(x,b) in a band b and spectral transmittance t(x,λ) of a corresponding point on the stained sample (a corresponding point).

g(x,b)=∫_{λ}f(b,λ)s(λ)e(λ)t(x,λ)dλ+n(b) (1)

In Equation (1), λ denotes a wavelength, f(b,λ) denotes a spectral-transmittance of a bth filter, s(λ) denotes a spectral sensitivity characteristic of the camera, e(λ) denotes a spectral emission characteristic of illumination, and n(b) denotes imaging noise in the band b. B denotes a serial number for identifying the band, and is an integer satisfying 1≦b≦16.

In practical calculation, the following Equation (2) obtained by the discretizing equation (1) in a wavelength direction is used

G(x)=FSET(x)+N (2)

When the number of samples in the wavelength direction is designated as D, and the number of bands is designated as B (here, B=16), G(x) denotes a matrix of B rows by one column corresponding to a pixel value g(x,b) at a position x. Similarly, T(x) denotes a matrix of D rows by one column corresponding to t(x,λ), and F denotes a matrix of B rows by D columns corresponding to f(b,λ). On the other hand, S denotes a diagonal matrix of D rows by D columns, and a diagonal element corresponds to s(λ). Similarly, E denotes a diagonal matrix of D rows by D columns, and a diagonal element corresponds to e(λ). N denotes a matrix of B rows by one column corresponding to n(b). In the equation (2), because expressions of a plurality of bands are put together using a matrix, a variable b expressing the band is not explicitly described. Further, an integral of a wavelength λ is replaced by a product of matrices.

To simplify description, a matrix H defined by the following equation (3) is introduced. H is also called as a system matrix.

H=FSE (3)

The spectral transmittance at each sample point is then estimated from the captured multiband image by using the Wiener estimation. An estimate value T̂(x) of the spectral transmittance can be calculated by the following equation (4). T̂ indicates that the hat (̂) expressing an estimate value is added above the letter T.

\hat{T}(x)=WG(x) (4)

W is expressed by the following Equation (5), and is referred to as “Wiener estimation matrix” or “estimation operator used in the Wiener estimation”. In the following explanations, W is simply referred to as “the estimation operator”.

W=R_{SS}H^{t}(HR_{SS}H^{t}+R_{NN})⁻¹ (5)

where ( )^{t}: transposed matrix, ( )⁻¹: inverse matrix.
In the Equation (5), R_{SS} is a matrix of D rows by D columns and represents an autocorrelation matrix of the spectral transmittance of the stained sample. R_{NN} is a matrix of B rows by B columns and represents an autocorrelation matrix of noise of the camera used for imaging. Thus, the estimation operator W includes a system matrix H, a term R_{SS} expressing statistical properties of the observed object, and a term R_{NN} expressing properties of imaging noise. Highly accurate expression of these properties leads to the improvement of the estimation accuracy of spectral transmittance.

### SUMMARY OF THE INVENTION

An image processing device according to an aspect of the present invention is for processing a stained sample image obtained by imaging a stained sample stained with at least one dye to estimate spectral characteristics of the stained sample. The image processing device includes a data-set generating unit that generates a plurality of data sets in which spectral information and color information corresponding to the spectral information are set as a pair; an associating unit that associates the stained sample image with at least one of the data sets generated by the data-set generating unit based on color information of the stained sample image and color information of the respective data sets; and a spectral-information extracting unit that extracts spectral information used for estimating spectral characteristics of the stained sample according to the association of data sets by the associating unit.

A data-set generating device according to another aspect of the present invention is for generating a data set used by an image processing device that processes a stained sample image obtained by imaging a stained sample stained with at least one dye to estimate spectral characteristics of the stained sample. The data-set generating device includes a data-set generating unit that generates a plurality of data sets in which spectral information and color information corresponding to the spectral information are set as a pair.

A computer readable storage medium according to still another aspect of the present invention stores an image processing program for processing a stained sample image obtained by imaging a stained sample stained with at least one dye to estimate spectral characteristics of the stained sample. The image processing program includes instructions for causing a computer to execute generating a plurality of data sets in which spectral information and color information corresponding to the spectral information are set as a pair; associating the stained sample image with at least one of the generated respective data sets based on color information of the stained sample image and color information of the respective data sets; and extracting spectral information used for estimating spectral characteristics of the stained sample according to the association of the data sets.

A computer readable storage medium according to still another aspect of the present invention stores an image processing program for processing a stained sample image obtained by imaging a stained sample stained with at least one dye to estimate spectral characteristics of the stained sample, by using a plurality of data sets in which spectral information and color information corresponding to the spectral information are set as a pair. The image processing program includes instructions for causing a computer to execute associating the stained sample image with at least one of the data sets based on color information of the stained sample image and color information of the respective data sets; and extracting spectral information used for estimating spectral characteristics of the stained sample according to the association of the data sets.

A computer readable storage medium according to still another aspect of the present invention stores a data-set generating program for generating a data set used in an image processing device that processes a stained sample image obtained by imaging a stained sample stained with at least one dye to estimate spectral characteristics of the stained sample. The data-set generating program includes instructions for causing a computer to execute generating a plurality of data sets in which spectral information and color information corresponding to the spectral information are set as a pair.

The above and other features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a configuration diagram of an image processing device;

FIG. 2 is a schematic diagram of an array example of a color filter and a pixel array of respective RGB bands;

FIG. 3A depicts spectral transmittance characteristics of one optical filter;

FIG. 3B depicts spectral transmittance characteristics of the other optical filter;

FIG. 4 is an example of spectral sensitivity of the R, G, and B bands;

FIG. 5 is a block diagram for explaining a functional configuration of the image processing device;

FIG. 6 is a data configuration example of a data set;

FIG. 7 is a flowchart of a process procedure performed by the image processing device;

FIG. 8 is a flowchart of a detailed process procedure of a data-set generating process;

FIG. 9 is an example of reference spectral characteristics of a dye H, a dye E, a dye R, and a dye G;

FIG. 10 is an example of spectral information acquired when a dye amount of the dye H, the dye E, the dye R, and the dye G is 1.0, respectively;

FIG. 11 is an example of a virtual color gamut;

FIG. 12 is an example of a positional relation between a mapping point of color information of an estimation target pixel and respective mapping points of a virtual color gamut corresponding to color information of respective data sets in a feature space;

FIG. 13 is an example of a request screen for a data-set selection request;

FIG. 14 is a block diagram for explaining a functional configuration of a data-set generating device;

FIG. 15 is a system configuration diagram of a configuration of a computer system to which an embodiment of the present invention is applied;

FIG. 16 is a block diagram of a configuration of a main unit in the computer system in FIG. 15; and

FIG. 17 is an example of an RGB image.

### DETAILED DESCRIPTION OF THE PREFERRED EMBODIMENTS

Exemplary embodiments of the present invention will be explained below in detail with reference to the accompanying drawings. In the embodiments, a case that an H&E stained sample (body tissue sample) is a subject of imaging, and a spectral transmittance spectrum is estimated as an optical spectrum of the subject from a multiband image, which is a stained sample image acquired by imaging the stained sample, is explained. The present invention is not limited to the embodiments. In addition, in the descriptions of the drawings, like parts are denoted by like reference numerals.

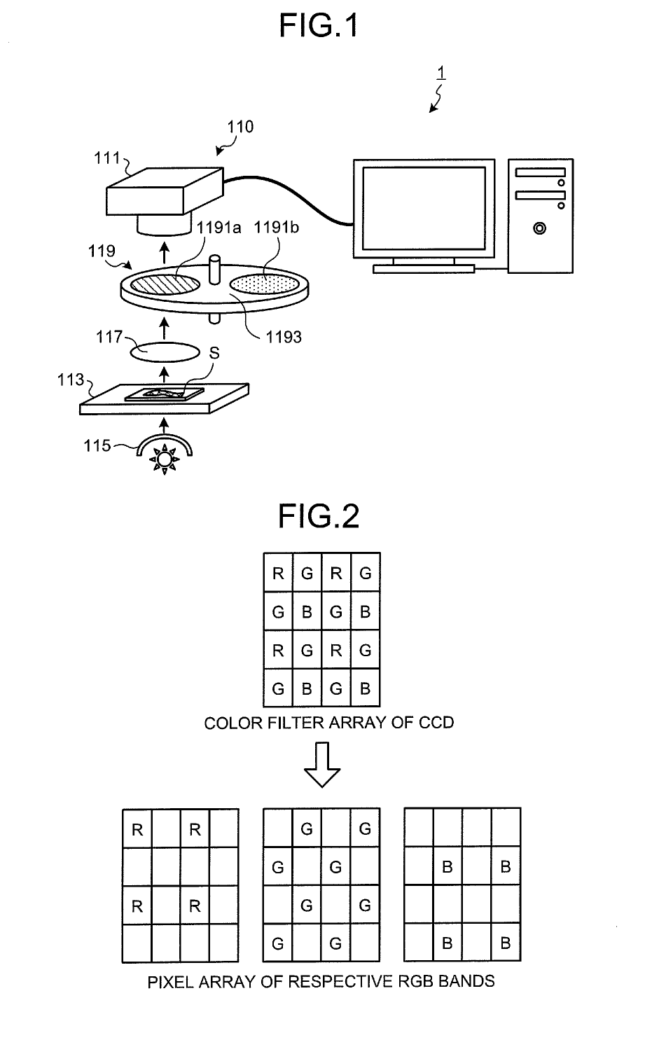

FIG. 1 is a schematic diagram for explaining a configuration of an image processing device according to the present embodiment. As shown in FIG. 1, an image processing device 1 is configured by a computer such as a personal computer, and includes an image acquiring unit 110 that acquires a multiband image of a sample.

The image acquiring unit 110 images an H&E stained sample whose spectral transmittance is to be estimated (hereinafter, “target sample”) by performing an image acquisition operation, and acquires a 6-band multiband image. The image acquiring unit 110 includes an RGB camera 111, a sample holding unit 113, an illuminating unit 115, an optical system 117, and a filter unit 119. The RGB camera 111 includes an imaging element such as a CCD. A target sample S is placed on the sample holding unit 113. The illuminating unit 115 transilluminates the target sample S on the sample holding unit 113. The optical system 117 collects transmitted light from the target sample S to form an image. The filter unit 119 limits a wavelength band of imaged light to a predetermined range.

The RGB camera 111 is widely used in a digital camera or the like, and RGB color filters are arranged in a mosaic pattern on a monochrome imaging element. The RGB camera 111 is set up so that the center of an image to be captured is positioned on an optical axis of illumination light. FIG. 2 is a schematic diagram of an array example of the color filter and a pixel array of respective RGB bands. In this case, each pixel can image only one of R, G, and B components; however, deficient R, G, and B components are interpolated by using a near pixel value. This method is disclosed in, for example, Japanese Patent No. 3510037. If a 3CCD camera is used, R, G, and B components in respective pixels can be acquired from the beginning. While any imaging method can be used in the present embodiment, it is assumed here that the R, G, and B components have been acquired in the respective pixels of the image captured by the RGB camera 111.

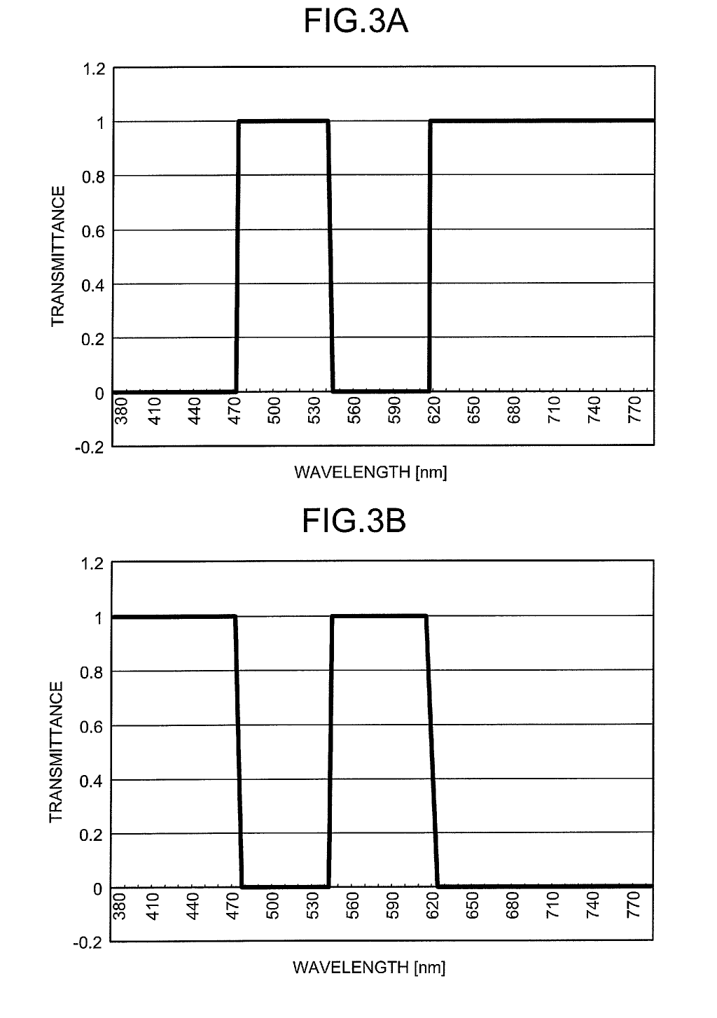

The filter unit 119 includes two optical filters 1191a and 1191b respectively having different spectral transmittance characteristics, and these optical filters are held by a rotary optical-filter switching unit 1193. FIG. 3A depicts spectral transmittance characteristics of one optical filter 1191a, and FIG. 3B depicts spectral transmittance characteristics of the other optical filter 1191b. For example, first imaging is performed by using the optical filter 1191a. The optical filter to be used is then switched to the optical filter 1191b by rotation of the optical-filter switching unit 1193, to perform second imaging by using the optical filter 1191b. A three-band image can be acquired respectively by the first and second imaging, and a 6-band multiband image can be acquired by combining these results. The number of optical filters is not limited to two, and three or more optical filters can be used. An example of combining the RGB camera and the optical filter is described here; however, the configuration is not limited thereto, and for example, a configuration in which a monochrome camera and an optical filter are combined can be used. The acquired multiband image is held in a storage unit 140 of the image processing device 1 as a target sample image.

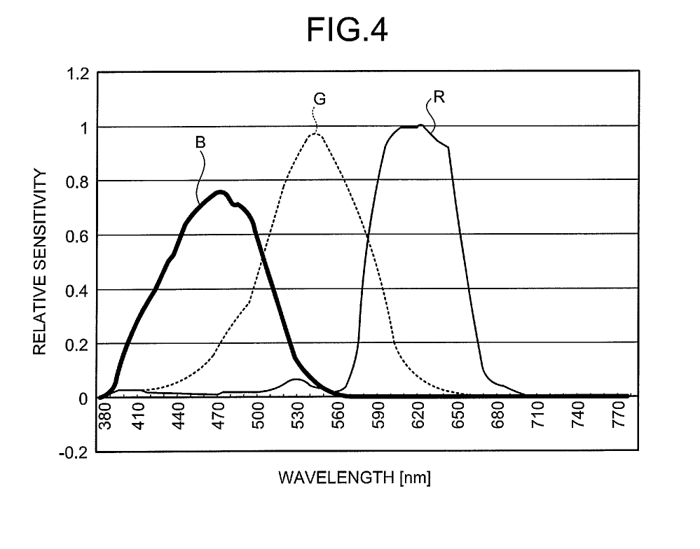

In the image acquiring unit 110, illumination light illuminated by the illuminating unit 115 transmits through the target sample S placed on the sample holding unit 113. Transmitted light through the target sample S passes through the optical system 117 and the optical filters 1191a and 1191b, to form an image on the imaging element of the RGB camera. The filter unit 119 including the optical filters 1191a and 1191b can be set up at any position on the optical path from the illuminating unit 115 to the RGB camera 111. An example of spectral sensitivity of the respective R, G, and B bands at the time of imaging illumination light from the illuminating unit 115 by the RGB camera 111 via the optical system 117 is shown in FIG. 4.

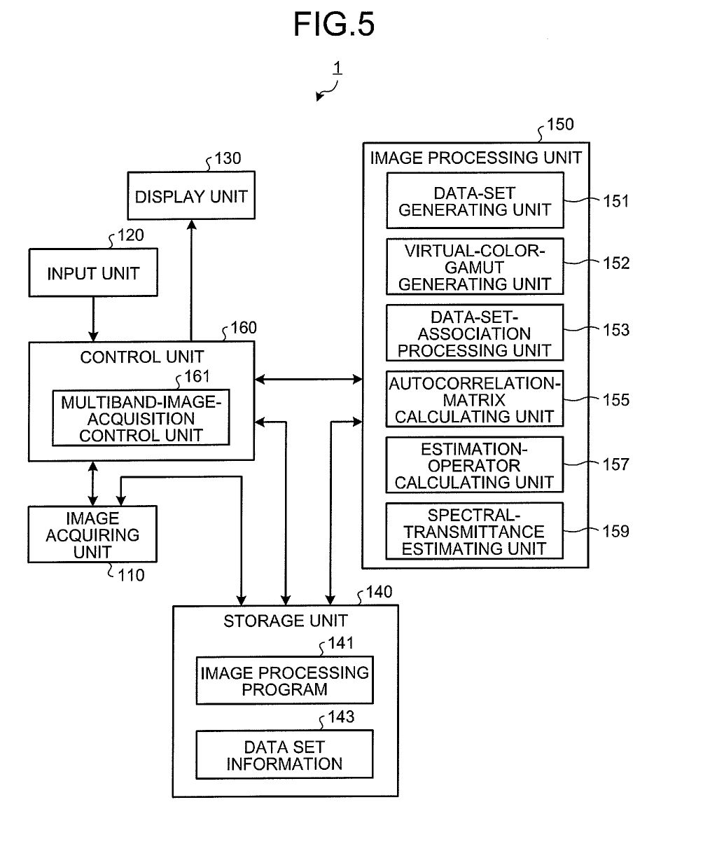

FIG. 5 is a block diagram for explaining a functional configuration of the image processing device 1. In the present embodiment, the image processing device 1 includes the image acquiring unit 110 shown and explained in FIG. 1, an input unit 120, a display unit 130, an image processing unit 150, the storage unit 140, and a control unit 160 that controls respective units.

The input unit 120 is realized by various input devices such as a keyboard, a mouse, a touch panel, and various switches, and outputs an operation signal in response to an operation input to the control unit 160. The display unit 130 is realized by a display device such as an LCD or EL display, and displays various screens based on a display signal input from the control unit 160.

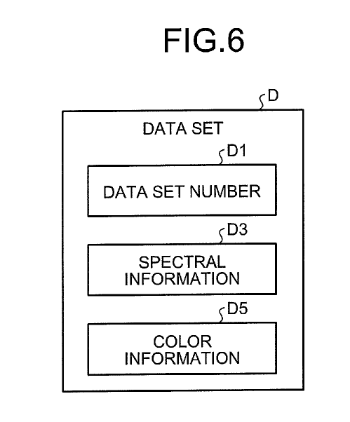

The storage unit 140 is realized by various IC memories such as a ROM and a RAM formed of a flash memory that can update and store data, a hard disk incorporated therein or connected by a data communication terminal, an information storage medium such as a CD-ROM, and a reader thereof. A program for operating the image processing device 1 and realizing various functions held by the image processing device 1, data to be used during execution of the program and the like are stored in the storage unit 140. The storage unit 140 also stores an image processing program 141. The image processing program 141 generates a plurality of data sets, in which spectral information and color information corresponding to the spectral information are set as a pair, and stores the data sets in the storage unit 140 as data set information 143. The image processing program 141 selects a data set corresponding to color information of an estimation target pixel from the data set information 143 and associates the data set with the estimation target pixel, and estimating a spectral transmittance of the estimation target pixel by using the spectral information of the data set. Further, the storage unit 140 stores the data set information 143 including a plurality of data sets in which spectral information and color information are set as a pair, as a data-set storage unit. FIG. 6 is a data configuration example of a data set D. As shown in FIG. 6, the data set D includes a data set number D1 for identifying the data set D, spectral information D3, and color information D5 corresponding to the spectral information.

The image processing unit 150 is realized by hardware such as a CPU. As shown in FIG. 5, the image processing unit 150 includes a data-set generating unit 151 as a data-set generating unit, a dye-amount setting unit, and a spectrum calculating unit, a virtual-color-gamut generating unit 152, a data-set-association processing unit 153 as an associating unit and a spectral-information extracting unit, an autocorrelation-matrix calculating unit 155, an estimation-operator calculating unit 157, and a spectral-transmittance estimating unit 159. The autocorrelation-matrix calculating unit 155, the estimation-operator calculating unit 157, and the spectral-transmittance estimating unit 159 are functional units corresponding to a spectral-characteristic estimating unit.

The data-set generating unit 151 generates spectral information and color information corresponding to the spectral information based on spectral characteristics of dyes contained in the stained sample, and associates the generated spectral information and color information with each other as a pair of data sets. More specifically, the data-set generating unit 151 generates the spectral information and the color information corresponding to the spectral information based on spectral characteristics of each dye contained in the stained sample, which becomes an estimation target of the spectral transmittance. The data-set generating unit 151 generates a plurality of data sets, and stores the data sets in the storage unit 140 as the data set information 143. The dyes contained in the stained sample include dyes held by the body tissue itself, other than orthochromatic dyes used for staining a sample. For example, the body tissue sample handled in the present embodiment includes cell nuclei, cell cytoplasm, red blood cells, a background area where there is no sample and the like. The stained sample acquired by subjecting the body tissue sample to the H&E stain includes four kinds of dyes, that is, a dye H, a dye E, a dye R, and a dye G. The dye H is hematoxylin that stains the cell nuclei. The dye E is eosin that stains the cell cytoplasm. The dye R is eosin that stains blood cells or a dye of an unstained red blood cell. That is, the red blood cell itself has a specific color even in an unstained state, and can be observed after the H&E stain such that the color of the red blood cell itself and the color of eosin changed in a staining process are superimposed on each other. Accordingly, in strict sense, one in which the color of the red blood cell and the color of eosin are mixed is referred to as the dye R. The dye G is a dye of the background, and specifically, is a dye of a slide glass on which the stained sample is placed.

The virtual-color-gamut generating unit 152 generates a virtual color gamut based on the color information of the respective data sets generated by the data-set generating unit 151. The data-set-association processing unit 153 selects a data set corresponding to the color information of an estimation target pixel of the spectral transmittance based on the virtual color gamut and associates the data set with the estimation target pixel.

The autocorrelation-matrix calculating unit 155 uses the spectral information of the data set associated with the estimation target pixel by the data-set-association processing unit 153 to calculates an autocorrelation matrix R_{SS} of the spectral transmittance of the stained sample (hereinafter, simply “autocorrelation matrix R_{SS}”). The estimation-operator calculating unit 157 uses the autocorrelation matrix R_{SS} calculated for the estimation target pixel by the autocorrelation-matrix calculating unit 155 to calculates an estimation operator W. The spectral-transmittance estimating unit 159 uses the estimated operator W calculated by the estimation-operator calculating unit 157 to estimate the spectral transmittance of a corresponding point corresponding to the estimation target pixel (hereinafter, “target sample point”).

The control unit 160 is realized by hardware such as a CPU. The control unit 160 issues a command to the respective units included in the image processing device 1 or transfers data based on an operation signal input from the input unit 120, image data input from the image acquiring unit 110, a program or data stored in the storage unit 140 or the like, and controls an operation of the entire image processing device 1 in an integrated manner. Further, the control unit 160 includes a multiband-image-acquisition control unit 161. The multiband-image-acquisition control unit 161 controls the operation of the image acquiring unit 110 to acquire a target sample image.

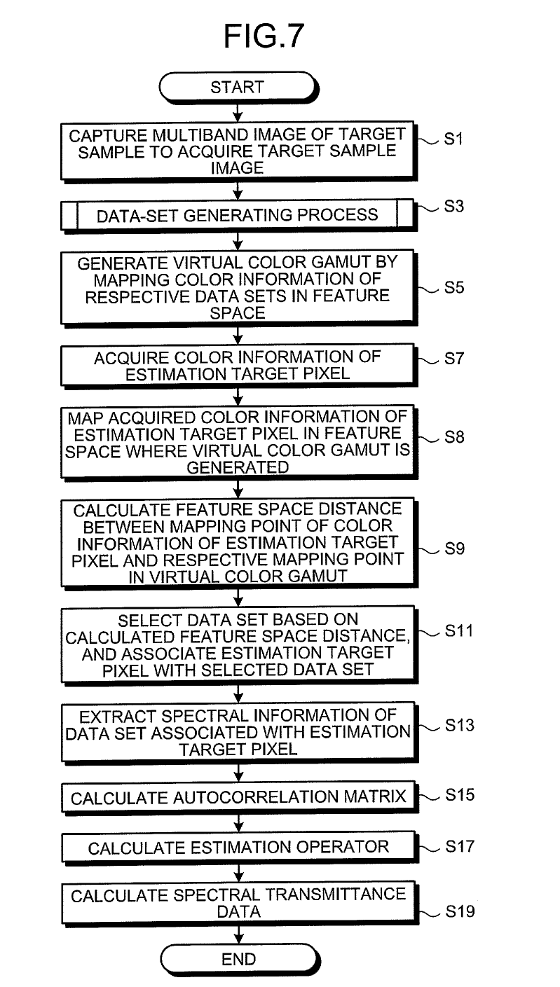

FIG. 7 is a flowchart of a process procedure performed by the image processing device 1. The processing to be explained here is realized by the respective units of the image processing device 1, which operate according to the image processing program 141 stored in the storage unit 140.

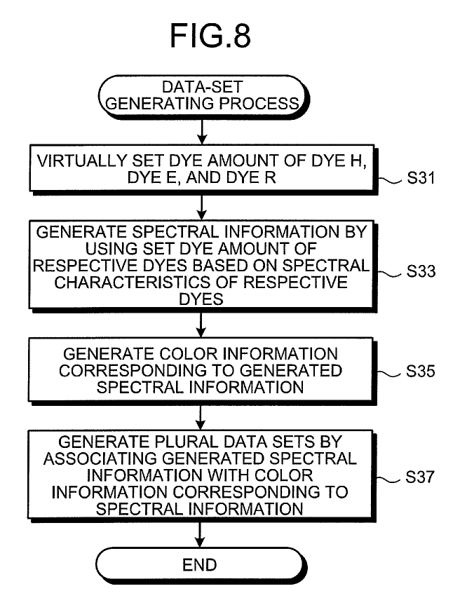

The multiband-image-acquisition control unit 161 first controls the operation of the image acquiring unit 110 to capture a multiband image of the target sample (Step S1). The image data of the acquired target sample image is stored in the storage unit 140. Subsequently, the data-set generating unit 151 performs a data-set generating process to generate a data set in which color information and spectral information corresponding to the color information are associated with each other (Step S3). FIG. 8 is a flowchart of a detailed process procedure of the data-set generating process.

In the data-set generating process, the data-set generating unit 151 virtually sets a dye amount of each of the dye H, the dye E, and the dye R (Step S31). Subsequently, the data-set generating unit 151 generates spectral information, when the dye amount of each dye is the dye amount set at Step S31, based on the spectral characteristics of the respective dyes (Step S33).

Generally, in a substance that transmits light, it is known that the Lambert-Beer law represented by the following Equation (6) is established between intensity I₀(λ) of incident light and intensity I(λ) of emitted light at each wavelength λ, where k(λ) denotes a value specific to the substance determined depending on the wavelength, and d denotes thickness of the substance. The left side of Equation (6) indicates spectral transmittance.

$$\frac{I ( λ )}{{I}_{0} ( λ )} = {e}^{- k ( λ ) \cdot d} \qquad ( 6 )$$

When the dyes contained in the stained sample are four kinds of the dye H, the dye E, the dye R, and the dye G, the following Equation (7) is established at each wavelength λ according to the Lambert-Beer law.

$$\frac{I ( λ )}{{I}_{0} ( λ )} = {e}^{- ( {k}_{H} ( λ ) \cdot {d}_{H} + {k}_{E} ( λ ) \cdot {d}_{E} + {k}_{R} ( λ ) \cdot {d}_{R} + {k}_{G} ( λ ) \cdot {d}_{G} )} \qquad ( 7 )$$

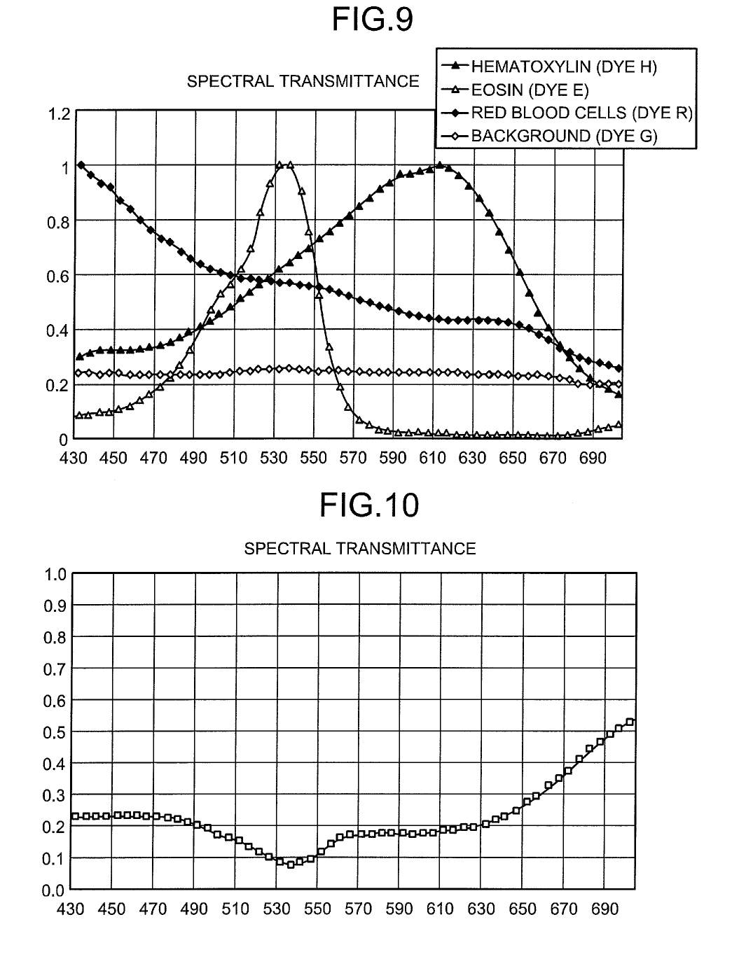

In Equation (7), k_{H}(λ), k_{E}(λ) k_{R}(λ), and k_{G}(λ) respectively denote k(λ) corresponding to each of the dye H, the dye E, the dye R, and the dye G, and a value of each k(λ) corresponds to the spectral characteristics of the corresponding dye. Hereinafter, each k(λ) is referred to as “reference spectral characteristic”. The respective k(λ) can be different for each organ and tissue to be stained, each region, and each race having these. Accordingly, a plurality of k(λ)s such as k(λ)₁, k(λ)₂, . . . are prepared for each dye corresponding to these differences, and corresponding k(λ) can be used. More specifically, k(λ) corresponding to each dye is prepared for each organ, tissue, region, and race, and k(λ) corresponding to the organ, tissue, region, and race, from which the target sample is extracted, can be appropriately selected and used. k_{H}(λ), k_{E}(λ), k_{R}(λ), and k_{G}(λ) can be obtained according to the Lambert-Beer law by preparing individually stained samples beforehand by using the dye H, the dye E, the dye R, and the dye G and measuring the spectral transmittance thereof by using a spectrometer or the like. FIG. 9 is an example of reference spectral characteristics of the respective dyes. The reference spectral characteristics of the respective dyes are stored in the storage unit 140 beforehand. Further, d_{H}, d_{E}, d_{R}, and d_{G} respectively indicate a virtual thickness of the dye H, the dye E, the dye R, and the dye G at a corresponding point on the sample corresponding to each image position of the multiband image. The dye is originally dispersed in the sample, and thus the thickness is not a correct idea. However, this can be an index of a relative dye amount indicating how much amount of dye is present, as compared to a case that the sample is assumed to consist of (stained with) a single dye. That is, it can be said that d_{H}, d_{E}, d_{R}, and d_{G} respectively indicate the dye amount of the dye H, the dye E, the dye R, and the dye G.

The data-set generating unit 151 uses Equation (7) to calculate the spectral transmittance by changing the dye amount of the respective dyes, and generates spectral information. That is, at Step S31 in FIG. 8, the data-set generating unit 151 generates several different combinations of values to be substituted in d_{H}, d_{E}, d_{R} respectively corresponding to the dye amount of the dye H, the dye E, and the dye R among d_{H}, d_{E}, d_{R}, and d_{G} to set the dye amount of the respective dyes. For example, the dye amount of the respective dyes is set by changing the dye amount of the respective dyes for each predetermined amount of change in a stepwise manner. The dye G is a dye of the slide glass, and the dye amount of the dye G is assumed to be a preset fixed value.

The amount of change in the dye amount is set so that a pixel value becomes different at least between specified dyes at the time of generating the color information based on the spectral information at Step S35 described later. The dye amount of each dye to be set is determined by taking into consideration a range of a value that can be taken by each dye amount of each dye, the reference spectral characteristics of the dye, the number of gradations of the pixel, a data amount of the data set information 143 and the like. Regarding the range of the value that can be taken by the dye amount, for example, a minimum value of the pixel value, that is, the dye amount of each dye with which a pixel value becomes 0 is set as an upper limit. Alternatively, the range can be set based on a dye amount with which a stained state with the dye is saturated. For example, when a limit value at which the color does not change even if the amount of the dye is changed further can be acquired beforehand, the range of the value that can be taken by the dye amount is set based on the limit value. Further, in practical staining of the sample, when the limit value of the dye amount capable of physically staining by the dye can be acquired beforehand, the data set need not be generated by assuming the stained state exceeding the limit value. Therefore, the range of the value that can be taken by the dye amount is set based on the limit value. Further, the number of data sets can be reduced according to the data amount of the data set information 143, to reduce the data amount. Reduction of the data amount is performed in a following manner. That is, after sets of spectral information and color information are generated by the data-set generating process (after Step S35), for example, the color information of each data set is mapped in an RGB space where each of RGB color components is designated as a feature axis. The data set is then sampled so that a distance between respective mapping points becomes substantially equidistant. Alternatively, the dye amount can be set densely by decreasing the amount of change in the dye amount set in a range where a change of color is large with respect to a change of the dye amount.

At Step S33, the data-set generating unit 151 substitutes the dye amount of the respective dyes set at Step S31 respectively in d_{H}, d_{E}, d_{R}, and d_{G} of Equation (7) to calculate the spectral transmittance thereof, and generates the spectral information. FIG. 10 is an example of the spectral information acquired when the dye amount of the dye H, the dye E, the dye R, and the dye G is 1.0, respectively, that is, when 1.0 is substituted in d_{H}, d_{R}, d_{R}, and d_{G} in Equation (7).

Subsequently, as shown in FIG. 8, the data-set generating unit 151 generates color information corresponding to the generated spectral information (Step S35). For example, the data-set generating unit 151 calculates a pixel value g(x,b) by using the following equation (1) shown in the related art, and generates the color information.

g(x,b)=∫_{λ}f(b,λ)s(λ)e(λ)t(x,λ)dλ+n(b) (1)

As described above, λ denotes a wavelength, f(b,λ) denotes a spectral transmittance of the bth filter, s(λ) denotes a spectral sensitivity characteristic of a camera, e(λ) denotes a spectral emission characteristic of illumination, and n(b) denotes imaging noise in the band b. B denotes a serial number for identifying the band, and is an integer that satisfies 1≦b≦6 in the present embodiment. It is assumed that the imaging noise is free. The color information is not limited to a case of using signal values of RGB components, and a value of another color component converted by using the signal values of the RGB components can be used.

The data-set generating unit 151 associates the generated spectral information with the color information corresponding to the spectral information to generate a plurality of data sets, and stores the data sets as the data set information 143 in the storage unit 140 (Step S37). Specifically, the data-set generating unit 151 respectively generates the spectral information and the color information for each of combinations of the dye amount of the dye H, the dye E, the dye R, and the dye G set at Step S31 to generate a plurality of data sets, and stores the data sets as the data set information 143 in the storage unit 140. The data-set generating unit 151 associates the spectral information (spectral transmittance) with the color information to generate the data sets; however, the data-set generating unit 151 can store the data set in the data set information 143, appropriately including the information of the dye amount of each dye used at the time of generating the spectral information, the reference spectral characteristics of each dye and the like in the data set. When the data-set generating process finishes, control returns to Step S3, and then proceeds to Step S5.

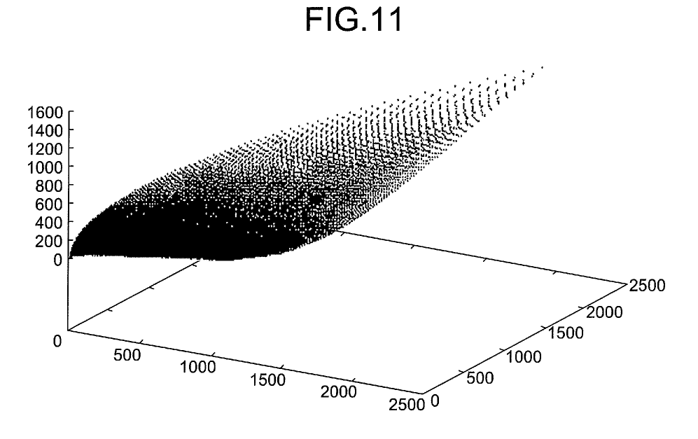

That is, at Step S5, the virtual-color-gamut generating unit 152 performs a virtual-color-gamut generating process to generate a virtual color gamut by mapping the color information of each data set in a feature space. As described above, the color information of each data set indicates a value generated based on the range of the value that can be taken by the color information of each dye, and the virtual color gamut acquired by mapping the color information of each data set in the feature space indicates a color range that can be taken by the stained sample. The virtual-color-gamut generating unit 152 forms the feature space corresponding to the number of dimensions of the color information, and distributes a mapping point of the color information of each data set in the feature space, thereby generating a virtual color gamut. FIG. 11 is an example of the virtual color gamut. For example, as shown in FIG. 11, the RGB space where each of RGB color components is designated as a feature axis is formed as the feature space. The virtual-color-gamut generating unit 152 adds the color information of each data set for each of the RGB components and maps the color information in the RGB space as a three-dimensional data point, to generate the virtual color gamut. Information of the generated virtual color gamut is stored in the storage unit 140. The color information of each data set can be converted from high-dimension information to low-dimension information by mapping the color information of each data set in the RGB space, thereby enabling to reduce the data amount. Reduction of the data amount can be appropriately performed. The generated virtual color gamut can be visually presented to a user. In this case, the control unit 160 controls the display unit 130 to display the virtual color gamut exemplified in FIG. 11.

The data set can be generated, assuming various stained states of the stained sample based on the reference spectral characteristics of the respective dyes without acquiring the spectral information, by preparing the samples in different stained states beforehand by the data-set generating process. The virtual color gamut can be generated from the color information of the generated data set by the virtual-color-gamut generating process.

When the data set is generated in the above-described manner and the virtual color gamut is generated, control proceeds to estimation of the spectral characteristics of a target sample to estimate the spectral transmittance at a target sample point on the target sample corresponding to an arbitrary point x in a target sample image (estimation target pixel of the spectral characteristics). That is, the data-set-association processing unit 153 performs a data-set associating process. Specifically, as shown in FIG. 7, the data-set-association processing unit 153 acquires the pixel value g(x,b) of the estimation target pixel as the color information (Step S7). When the color information of each data set is converted from high-dimension information to low-dimension information at the time of generating the virtual color gamut, the virtual-color-gamut generating unit 152 converts the number of dimensions in the same manner for the acquired color information of the estimation target pixel. When the data-set generating unit 151 generates a value of another color component converted by using signal values of the RGB components as the color information, the virtual-color-gamut generating unit 152 converts the acquired color information of the estimation target pixel to a value of the other color component in the same manner.

Subsequently, the data-set-association processing unit 153 maps the acquired color information of the estimation target pixel at one point in the feature space where the virtual color gamut is generated by the virtual-color-gamut generating unit 152 at Step S5 in FIG. 7 (Step S8). Serial number b for identifying a band is 1≦b≦6 in the present embodiment, and for example, the color information can be mapped at one point in the feature space determined by each pixel value.

The data-set-association processing unit 153 calculates a distance dᵢ in the feature space (hereinafter, “feature space distance”) between a mapping point of the color information of the estimation target pixel in the virtual color gamut and respective mapping points (data points) of the virtual color gamut corresponding to the color information of the respective data sets according to the following Equation (8) (Step S9), where k denotes a data set number allocated to a data set corresponding to the estimation target pixel, and b denotes a band number. Further, xᵢ is a mapping point of the color information of the corresponding data set, and x is a mapping point of the color information of the estimation target pixel.

$${d}_{i} = \sqrt{{\sum }_{b} {( {x}_{i , b} - {x}_{b} )}^{2}} \qquad ( 8 )$$

The data-set-association processing unit 153 selects a data set having a calculated feature space distance equal to or less than a predetermined threshold, and associates the selected data set with the data set from which the estimation target pixel is selected (Step S11). When there is the color information matching the color information of the estimation target pixel, that is, when there is a data set of the color information in which a value of the feature space distance is 0, the data-set-association processing unit 153 selects this data set. Information of the selected data set (for example, data set number) is stored in the storage unit 140 together with the feature space distance dᵢ between the mapping point of the estimation target pixel and the mapping point corresponding to the color information thereof.

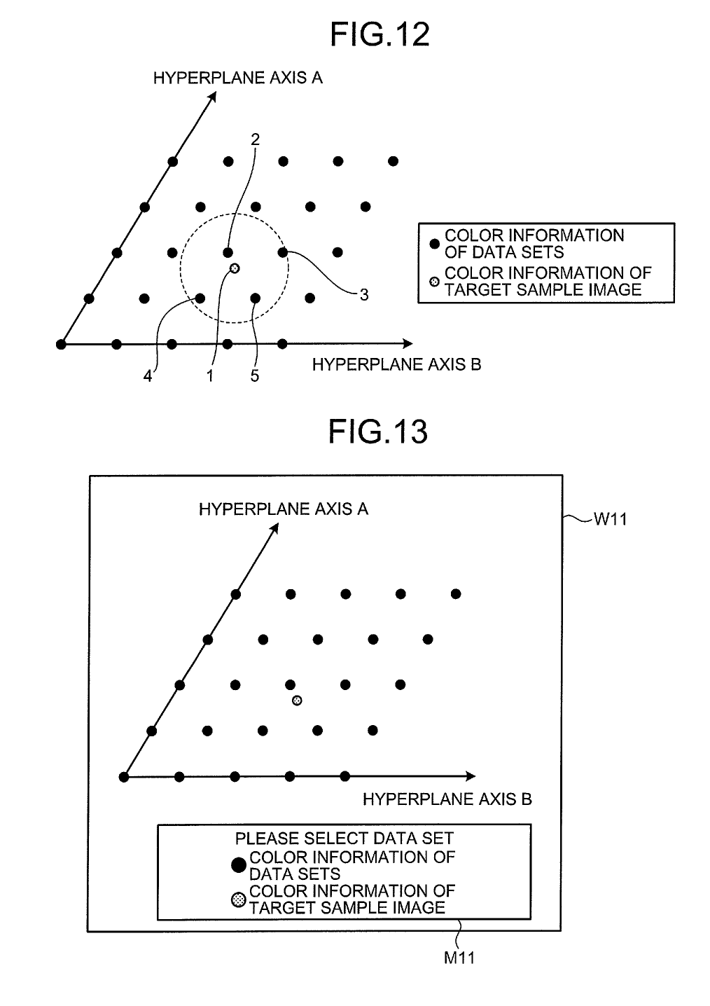

FIG. 12 is an example of a positional relation between the mapping point of the color information of the estimation target pixel and the respective mapping points of the virtual color gamut corresponding to the color information of the respective data sets in a feature space, and FIG. 12 depicts a state where the estimation target pixel is associated with the data set. For example, in an example in FIG. 12, four mapping points 2 to 5 are extracted from the respective mapping points of the virtual color gamut. That is, four mapping points 2 to 5 are extracted in which the feature space distance from mapping point 1 of the color information of the estimation target pixel is included in an area enclosed by broken line indicating a predetermined threshold, and the data sets of the color information corresponding to respective mapping points 2 to 5 are selected and associated with the estimation target pixel.

The data-set-association processing unit 153 extracts the spectral information of the data sets associated with the estimation target pixel as the spectral information used for estimating the spectral characteristics of the estimation target pixel (Step S13).

According to the data-set associating process performed in this manner, an appropriate data set can be selected based on the color information of the estimation target pixel and the color information of the respective data sets, and associated with the estimation target pixel. The appropriate spectral information corresponding to the color information of the estimation target pixel can be extracted as the spectral information used for estimating the spectral characteristics of the estimation target pixel.

Subsequently, as shown in FIG. 7, the autocorrelation-matrix calculating unit 155 performs an autocorrelation-matrix calculating process to calculate an autocorrelation matrix R_{SS} by using the spectral information extracted at Step S13 (Step S15). Specifically, the autocorrelation-matrix calculating unit 155 calculates a determinant V of a weighted mean vector of the spectral transmittance based on the feature space distance dᵢ calculated for the color information of the respective data sets associated with the estimation target pixel, according to the following Equation (9).

$$V = {\sum }_{i} p ( {d}_{i} ) \cdot {V}_{i} \qquad ( 9 )$$

In Equation (9), p(dᵢ) denotes probability distribution calculated by using the feature space distance dᵢ, and is calculated according to the following Equation (10), i denotes a data set number of the data set associated with the estimation target pixel, and Σⱼ denotes a covariance matrix.

$$p ( {d}_{i} ) = {( 2 π )}^{- 1} {\vert {\sum }_{j} \vert}^{- b / 2} exp \{ - \frac{1}{2 } {( {d}_{ij} )}^{T} {\sum }_{j}^{- 1} ( {d}_{ij} ) \} \qquad ( 10 )$$

Weighting of existence probability in the feature space distance dᵢ is performed with respect to the data sets associated with the estimation target pixel by adjusting the covariance matrix Σⱼ according to Equation (9). When one data set whose color information matches the color information of the estimation target pixel is selected and associated with the estimation target pixel at Step S11, the weighting process can be dispensed with.

Subsequently, the autocorrelation-matrix calculating unit 155 uses a calculated weighted mean vector V to calculate the autocorrelation matrix R_{SS} according to the following Equation (11), where T denotes transposition of the determinant.

R_{SS}=V·V^{T} (11)

By the autocorrelation-matrix calculating process performed in this manner, the autocorrelation matrix R_{SS} can be calculated based on the spectral information extracted from the data set associated with the estimation target pixel. Therefore, an appropriate autocorrelation matrix R_{SS} can be calculated by using the spectral information corresponding to the color information of the estimation target pixel of the spectral characteristics.

Subsequently, as shown in FIG. 7, the estimation-operator calculating unit 157 performs an estimation-operator calculating process to calculate the estimation operator W used for the Wiener estimation by using the autocorrelation matrix R_{SS} calculated at Step S15 (Step S17). Specifically, the estimation operator W is calculated according to the following Equation (5) shown in the related art.

W=R_{SS}H^{t}(HR_{SS}H^{t}+R_{NN})⁻¹ (5)

As shown in the related art, a system matrix H defined by the following Equation (3) is introduced here.

H=FSE (3)

Respective values of spectral transmittance F of the optical filters 1191a and 1191b, a spectral sensitivity characteristic S of the RGB camera 111, and a spectral emission characteristic E(̂) of illumination per unit time are measured by using a spectrometer or the like, after selecting materials to be used for respective units included in the image acquiring unit 110. The autocorrelation matrix R_{NN} of noise of the RGB camera 111 is calculated by using a pixel value of the estimation target pixel. That is, a multiband image is acquired beforehand by the image acquiring unit 110 without setting up a sample in a state that there is no sample. Dispersion of a pixel value with respect to the pixel value is obtained for each band of the acquired multiband image, to calculate an approximate expression based on the pixel value and the dispersion of the pixel value. Dispersion of the pixel value with respect to the pixel value of the estimation target pixel is then obtained by using the calculated approximate expression, and generates a matrix in which the obtained dispersion is designated as a diagonal component, thereby calculating the autocorrelation matrix R_{NN} of noise. It is assumed here that there is no correlation of noise between bands.

By the estimation-operator calculating process performed in this manner, the estimation operator W can be calculated by using the autocorrelation matrix R_{SS} calculated for the estimation target pixel by the autocorrelation-matrix calculating unit 155. Accordingly, an appropriate estimation operator W corresponding to the color information of the estimation target pixel can be calculated.

Subsequently, the spectral-transmittance estimating unit 159 uses the estimation operator W calculated at Step S17 to calculate spectral transmittance data at a target sample point on the target sample corresponding to the estimation target pixel (Step S19). Specifically, the spectral-transmittance estimating unit 159 estimates an estimate value of the spectral transmittance (spectral transmittance data) T̂(x) at the corresponding target sample point based on matrix representation G(x) of the pixel value of a pixel at an arbitrary point x of the target sample image, which is the estimation target pixel, according to Equation (4) shown in the related art. The acquired estimate value T̂(x) of the spectral transmittance is stored in the storage unit 140.

\hat{T}(x)=WG(x) (4)

In this manner, the estimation-operator calculating unit 157 can use the estimation operator W calculated for the estimation target pixel, to calculate the spectral transmittance data of the estimation target pixel. Accordingly, even when stained samples in various stained states are estimation targets of the spectral characteristics, an estimation error of the spectral characteristics, which occurs due to the stained state of the stained sample, can be reduced without acquiring the spectral information from a sample stained in the same stained state as that of the stained sample beforehand. Accordingly, the estimation accuracy of spectral characteristics of the stained sample can be improved.

The spectral transmittance estimated by the image processing device 1 is used, for example, for estimating the dye amount of the dye that stains the target sample. The color of the image is corrected based on the estimated dye amount, and the characteristics of the camera and a difference in the stained state are corrected to combine an RGB image for display. The RGB image is displayed on the screen of the display unit 130 and is used for the pathological diagnosis.

In the embodiment described above, a data set of appropriate color information is automatically selected from the data set information 143 and associated with the estimation target pixel based on the color information of the estimation target pixel; however, the present invention is not limited thereto. For example, the color information of the estimation target pixel and the color information of the data set are visually presented to a user, and the data set to be associated with the estimation target pixel can be selected according to a user operation. In this case, the control unit 160 performs control to display a positional relation between a mapping point of the color information of the estimation target pixel and respective mapping points of the virtual color gamut corresponding to the color information of the respective data sets in a feature space shown, for example, in FIG. 12 on the display unit 130. At this time, the control unit 160 performs control to display a selection request of one or plural data sets, and functions as a display controller and a data-set-selection requesting unit. FIG. 13 is an example of a request screen W11 for a data-set selection request. In the request screen W11, a message Mil indicating a request for selecting a data set is displayed. The user specifies the color information of one or plural data sets via the input unit 120 to select a data set to be associated with the estimation target pixel.

In the embodiment described above, the image processing device 1 including the data-set generating unit 151 that generates the data set information 143 has been explained; however, the image processing device 1 can have a configuration such that the data set information generated by another data-set generating device beforehand is stored in the storage unit. Further, regarding the virtual color gamut generated from the color information of the respective data sets, the one generated by the data-set generating device or the like beforehand can be stored in the storage unit. In this case, the image processing device can be realized in a configuration in which at least one of the data-set generating unit 151 and the virtual-color-gamut generating unit 152 shown in FIG. 5 is not included.

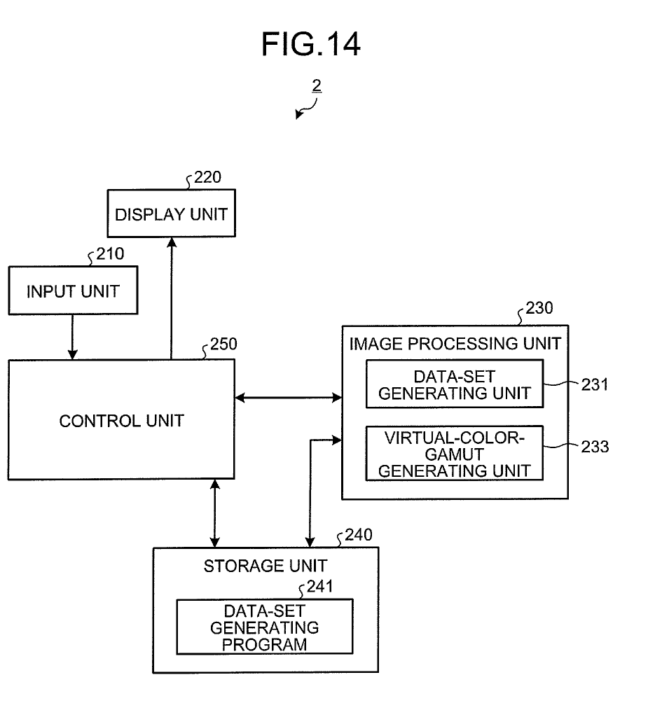

On the other hand, the data-set generating device that generates the data set information includes at least one of a data-set generating unit 231 and a virtual-color-gamut generating unit 233 shown in FIG. 14. FIG. 14 is a block diagram for explaining a functional configuration of a data-set generating device 2. As shown in FIG. 14, the data-set generating device 2 includes an input unit 210, a display unit 220, an image processing unit 230, a storage unit 240, and a control unit 250 that controls the respective units of the device. The image processing unit 230 includes the data-set generating unit 231 that performs the data-set generating process in the above embodiment and the virtual-color-gamut generating unit 233 that performs the virtual-color-gamut generating process. A data-set generating program 241 for realizing the data-set generating process and the virtual-color-gamut generating process is stored in the storage unit 240. Further, data of the spectral characteristics (reference spectral characteristics) of the dye used in execution of the data-set generating program 241 is stored in the storage unit 240, other than information of the data set generated by the data-set generating process, and information of the virtual color gamut generated by the virtual-color-gamut generating process.

In the embodiment described above, a case that a data set is generated by using the spectral transmittance calculated according to Equation (7) as the spectral information has been explained; however, the present invention is not limited thereto. For example, a mean vector of the calculated spectral transmittance, an autocorrelation matrix calculated based on the spectral transmittance, a covariance matrix calculated based on the spectral transmittance, an estimation operator W calculated by using the autocorrelation matrix or the covariance matrix, an estimated spectrum calculated based on the estimation operator W and the like can be used. Any one of these can be used as the spectral information or a plurality of pieces of information can be used as the spectral information.

In the embodiment described above, a case that a spectrum characteristic value of the spectral transmittance is estimated based on the multiband image obtained by imaging a pathological specimen has been explained; however, the present invention is similarly applicable to a case that spectrum characteristics of spectral reflectivity are estimated as a spectral spectrum.

In the embodiment described above, a case that an H&E stained pathological specimen is subjected to transmission observation has been explained; however, the present invention is also applicable to a biological sample stained by using other staining methods. Further, the present invention can be applied not only to observation of transmitted light but also to observation of reflecting light, fluorescence, and emission of light.

The image processing device 1 and the data-set generating device 2 can be realized by executing a program prepared beforehand by a computer system such as a personal computer or a workstation. A computer system having the same function as that of the image processing device 1 and the data-set generating device 2, which executes the image processing program 141 and the data-set generating program 241, is explained below.

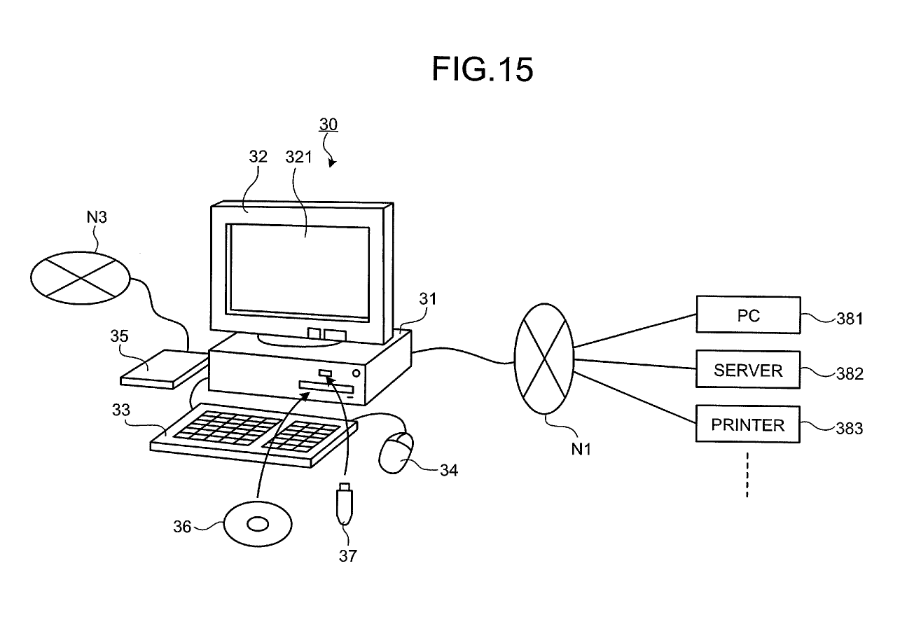

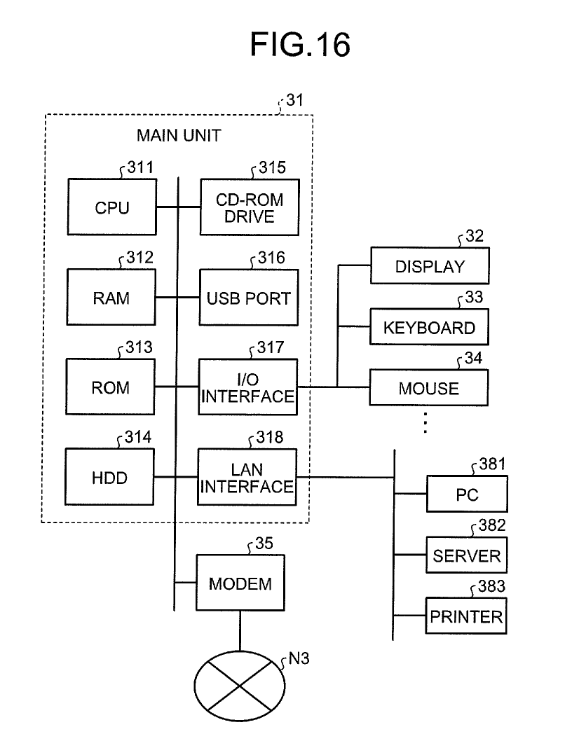

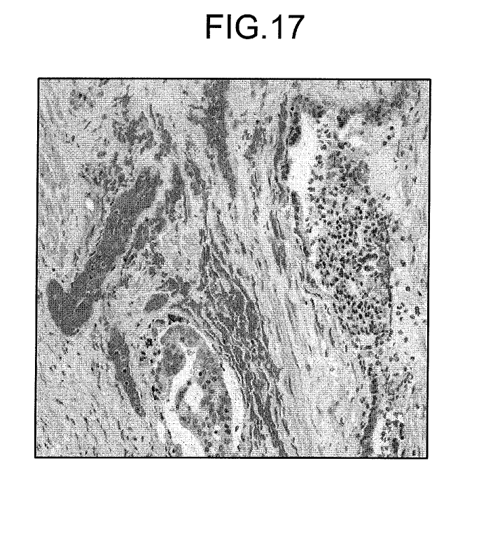

FIG. 15 is a system configuration diagram of a configuration of a computer system 30, and FIG. 16 is a block diagram of a configuration of a main unit 31 in the computer system 30. As shown in FIG. 15, the computer system 30 includes the main unit 31 and a display 32 that displays information such as an image on a display screen 321 in response to an instruction from the main unit 31. The computer system 30 also includes a keyboard 33 that inputs various pieces of information to the computer system 30 and a mouse 34 that specifies an arbitrary position on the display screen 321 of the display 32.

The main unit 31 in the computer system 30 includes, as shown in FIG. 16, a CPU 311, a RAM 312, a ROM 313, a hard disk drive (HDD) 314, a CD-ROM drive 315 that accepts a CD-ROM, a USB port 316 that detachably connects a USB memory 37, an I/O interface 317 that connects the display 32, the keyboard 33, and the mouse 34, and a LAN interface 318 for connecting to a local area network or a wide area network (LAN/WAN) N1.

Furthermore, a modem 35 that connects to a public line N3 such as the Internet is connected to the computer system 30, and a personal computer (PC) 381 as another computer system, a server 382, a printer 383 and the like are connected to the computer system 30 via the LAN interface 318 and the local area network or the wide area network N1.

The computer system 30 realizes an image processing device by reading and executing the image processing program stored in a predetermined storage medium. Alternatively, the computer system 30 realizes a data-set generating device by reading and executing the data-set generating program stored in the predetermined storage medium. The predetermined storage medium includes any storage medium that stores the image processing program or the data-set generating program that can be read by the computer system 30. For example, the predetermined storage medium can be “portable physical medium” including an MO disk, a DVD disk, a flexible disk (FD), a magneto-optical disk, and an IC card, other than a CD-ROM 36 and the USB memory 37; “fixed physical medium” such as the HDD 314, the RAM 312, and the ROM 313 provided inside and outside of the computer system 30; and “communication medium” that holds a program for a short period of time at the time of transmitting a program, such as the public line N3 connected via the modem 35, and the local area network or the wide area network N1 to which the another computer system (PC) 381 or the server 382 is connected.

That is, the image processing program and the data-set generating program are stored in a computer-readable manner in the storage medium such as the “portable physical medium”, “fixed physical medium”, and “communication medium”. The computer system 30 realizes an image processing device by reading and executing the image processing program from such a storage medium. Alternatively, the computer system 30 realizes a data-set generating device by reading and executing the data-set generating program from a storage medium. The image processing program and the data-set generating program are not limited to be executed by the computer system 30, and the present invention can be applied to a case that the another computer system (PC) 381 or the server 382 executes the image processing program or the data-set generating program, and a case that the another computer system (PC) 381 and the server 382 cooperate to execute the image processing program and the data-set generating program.

According to the present invention, a data set can be generated as a pair of spectral information and color information corresponding to the spectral information, and spectral characteristics of a stained sample can be extracted as the spectral information to be used for estimating the spectral characteristics of the stained sample, by using the spectral information of the data set corresponding to the color information of a stained sample image. With this method, even when stained samples in various stained states are estimation targets of the spectral characteristics, an estimation error of the spectral characteristics, which occurs due to the stained state of the stained sample, can be reduced without acquiring the spectral information from a sample stained in the same stained state as that of the stained sample beforehand. Accordingly, the estimation accuracy of the spectral characteristics of the stained sample can be improved.

The above and other features, advantages and technical and industrial significance of this invention will be better understood by reading the following detailed description of presently preferred embodiments of the invention, when considered in connection with the accompanying drawings.

What is claimed is:

1. An image processing device for processing a stained sample image obtained by imaging a stained sample stained with at least one dye to estimate spectral characteristics of the stained sample, the image processing device comprising:
a data-set generating unit that generates a plurality of data sets in which spectral information and color information corresponding to the spectral information are set as a pair;
an associating unit that associates the stained sample image with at least one of the data sets generated by the data-set generating unit based on color information of the stained sample image and color information of the respective data sets; and
a spectral-information extracting unit that extracts spectral information used for estimating spectral characteristics of the stained sample according to the association of data sets by the associating unit.

2. The image processing device according to claim 1, wherein the data-set generating unit generates spectral information and color information corresponding to the spectral information based on spectral characteristics of dyes contained in the stained sample, and associates generated spectral information and color information with each other to generate the data sets.

3. The image processing device according to claim 2, wherein
the data-set generating unit comprises:
a dye-amount setting unit that virtually sets a dye amount of dyes contained in the stained sample; and
a spectrum calculating unit that calculates a spectral spectrum by using the dye amount set by the dye-amount setting unit, based on spectral characteristics of dyes contained in the stained sample, wherein
the data-set generating unit generates the spectral information based on the spectral spectrum calculated by the spectrum calculating unit.

4. The image processing device according to claim 3, wherein the data-set generating unit generates the color information based on the spectral spectrum calculated by the spectrum calculating unit.

5. The image processing device according to claim 1, further comprising a virtual-color-gamut generating unit that generates a virtual color gamut by mapping color information of the respective data sets in a predetermined feature space.

6. The image processing device according to claim 5, wherein the associating unit performs the association of the data sets by mapping color information of the stained sample image in the feature space where the virtual color gamut is generated by the virtual-color-gamut generating unit.

7. The image processing device according to claim 6, wherein the associating unit calculates a feature space distance between a mapping point of color information of the stained sample image and mapping points of color information of the respective data sets forming the virtual color gamut, and performs the association of the data sets based on the calculated feature space distance.

8. The image processing device according to claim 7, comprising a spectral-characteristic estimating unit that estimates spectral characteristics of the stained sample by using the feature space distance calculated for color information of data sets, from which the spectral information is extracted, based on spectral information extracted by the spectral-information extracting unit.

9. The image processing device according to claim 1, comprising:
a display control unit that performs control to display at least color information of the stained sample image and color information of the respective data sets on a display unit; and
a data-set-selection requesting unit that requests selection of a data set to be associated with the stained sample image, wherein
the associating unit associates the stained sample image with a data set selected in response to a request by the data-set-selection requesting unit.

10. An image processing device for processing a stained sample image obtained by imaging a stained sample stained with at least one dye to estimate spectral characteristics of the stained sample, the image processing device comprising:
a data-set storage unit that stores therein a plurality of data sets in which spectral information and color information corresponding to the spectral information are set as a pair;
an associating unit that associates the stained sample image with at least one of the data sets stored in the data-set storage unit based on color information of the stained sample image and color information of the respective data sets; and
a spectral-information extracting unit that extracts spectral information used for estimating spectral characteristics of the stained sample according to the association of data sets by the associating unit.

11. A data-set generating device for generating a data set used by an image processing device that processes a stained sample image obtained by imaging a stained sample stained with at least one dye to estimate spectral characteristics of the stained sample, the data-set generating device comprising
a data-set generating unit that generates a plurality of data sets in which spectral information and color information corresponding to the spectral information are set as a pair.

12. A computer readable storage medium storing an image processing program for processing a stained sample image obtained by imaging a stained sample stained with at least one dye to estimate spectral characteristics of the stained sample, wherein
the image processing program includes instructions for causing a computer to execute:
generating a plurality of data sets in which spectral information and color information corresponding to the spectral information are set as a pair;
associating the stained sample image with at least one of the generated respective data sets based on color information of the stained sample image and color information of the respective data sets; and
extracting spectral information used for estimating spectral characteristics of the stained sample according to the association of the data sets.

13. A computer readable storage medium storing an image processing program for processing a stained sample image obtained by imaging a stained sample stained with at least one dye to estimate spectral characteristics of the stained sample, by using a plurality of data sets in which spectral information and color information corresponding, to the spectral information are set as a pair, wherein
the image processing program includes instructions for causing a computer to execute:
associating the stained sample image with at least one of the data sets based on color information of the stained sample image and color information of the respective data sets; and
extracting spectral information used for estimating spectral characteristics of the stained sample according to the association of the data sets.

14. A computer readable storage medium storing a data-set generating program for generating a data set used in an image processing device that processes a stained sample image obtained by imaging a stained sample stained with at least one dye to estimate spectral characteristics of the stained sample, wherein
the data-set generating program includes instructions for causing a computer to execute generating a plurality of data sets in which spectral information and color information corresponding to the spectral information are set as a pair.
